(19) United States
(12) Patent Application Publication
(10) Pub. No.: US 2009/0079836 A1
(43) Pub. Date: Mar. 26, 2009

(54) IMAGE PROCESSING APPARATUS, METHOD, AND COMPUTER PROGRAM PRODUCT

(76) Inventors: Nao Mishima, Tokyo (JP); Yasutoyo Takeyama, Kanagawa (JP); Masahiro Baba, Kanagawa (JP); Goh Itoh, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/235,108

(22) Filed: Sep. 22, 2008

(30) Foreign Application Priority Data
Sep. 25, 2007 (JP) 2007-247996

(51) Int. Cl. G06K 9/32; H04N 5/228

(52) U.S. Cl. 348/208.4; 382/300; 348/E05.024

(57) ABSTRACT

An image processing apparatus includes a correction-amount calculating unit that calculates a motion-blur correction amount, which takes a larger value as the reproduction speed becomes lower, based on an input reproduction speed; a motion-blur correcting unit that performs scale transformation on a motion vector based on the motion-blur correction amount, acquires low frequency components of a source image and a destination image using an anisotropic Gaussian filter determined by a direction and a size of the motion vector subjected to the scale transformation, and performs edge enhancement on the source image and the destination image based on the low frequency components and high frequency components of the source image and the destination image; and an interpolation-image creating unit that creates the interpolation image using the source image for which the motion blur is corrected, the destination image for which the motion blur is corrected, and the motion vector.

### CROSS-REFERENCE TO RELATED APPLICATIONS

This application is based upon and claims the benefit of priority from the prior Japanese Patent Application No. 2007-247996, filed on Sep. 25, 2007; the entire contents of which are incorporated herein by reference.

### BACKGROUND OF THE INVENTION

1. Field of the Invention

The present invention relates to an apparatus, a method, and a computer program product for image processing that enable to change a reproduction speed of moving images by interpolating an interpolation image between a source image and a destination image that are temporally adjacent to each other in the input moving images.

2. Description of the Related Art

In image processing apparatuses that change a reproduction speed of moving images, when moving images are played in slow motion by making a reproduction speed slow, a plurality of identical frames are interpolated between a source image and a destination image that are temporally adjacent to each other.

However, by this method, smoothness in movement is lost, resulting in unsmooth images. Therefore, in the technique disclosed in JP-A 2001-203983 (KOKAI), the movement between the source image and the destination image that are adjacent frames is estimated, and interpolation images are created based on estimated motion vectors. Further, the created interpolation images are interpolated between the source image and the destination image, thereby enabling slow reproduction with a smooth movement.

However, when moving images are imaged by a video camera or the like, a motion blur is caused on an imaged object depending on a moving speed of the object and a shutter speed (exposure time). If the shutter speed is fixed, as the object moves faster, the motion blur is more likely to be caused. Playing in slow motion is equivalent to making the movement of an object relatively slow. Considering this, if the movement of the object becomes slow, the motion blur should appear less.

However, in the technique disclosed in JP-A 2001-203983 (KOKAI), the interpolation images are created using frames of the source image and the destination image, which are the original images, as they are to be interpolated. Therefore, images are reproduced in slow motion using frames of large motion blurs, and the slow reproduction is performed with unnatural images.

### SUMMARY OF THE INVENTION

According to one aspect of the present invention, an image processing apparatus that interpolates an interpolation image corresponding to a reproduction speed between a source image and a destination image, the apparatus includes a motion estimating unit that estimates a motion vector of each pixel from the source image to the destination image; a correction-amount calculating unit that calculates a motion-blur correction amount, which takes a larger value as the reproduction speed becomes lower, based on an input reproduction speed; a motion-blur correcting unit that performs scale transformation on the motion vector based on the motion-blur correction amount, and corrects a motion blur of the source image and the destination image based on the motion vector subjected to the scale transformation; and an interpolation-image creating unit that creates the interpolation image using the source image for which the motion blur is corrected, the destination image for which the motion blur is corrected, and the motion vector, wherein the motion-blur correcting unit acquires respective low frequency components of the source image and the destination image by using an anisotropic Gaussian filter that is determined by a direction and a size of a motion vector subjected to a scale transformation, and performs edge enhancement on the source image and the destination image based on the low frequency components and respective high frequency components of the source image and the destination image, thereby correcting the motion blur of the source image and the destination image.

According to another aspect of the present invention, an image processing method executed in an image processing apparatus that interpolates an interpolation image corresponding to a reproduction speed between a source image and a destination image, the method includes estimating a motion vector of each pixel from the source image to the destination image; calculating a motion-blur correction amount, which takes a larger value as the reproduction speed becomes lower, based on an input reproduction speed; performing scale transformation on the motion vector based on the motion-blur correction amount, and correcting a motion blur of the source image and the destination image based on the motion vector subjected to the scale transformation; and creating the interpolation image using the source image for which the motion blur is corrected, the destination image for which the motion blur is corrected, and the motion vector, wherein in the correcting, respective low frequency components of the source image and the destination image are acquired by using an anisotropic Gaussian filter that is determined by a direction and a size of a motion vector subjected to a scale transformation, and an edge enhancement on the source image and the destination image is performed based on the low frequency components and respective high frequency components of the source image and the destination image, thereby correcting the motion blur of the source image and the destination image.

A computer program product according to still another aspect of the present invention causes a computer to perform the method according to the present invention.

### BRIEF DESCRIPTION OF THE DRAWINGS

FIG. 1 is a block diagram of a functional configuration of an image processing apparatus according to a first embodiment of the present invention;

FIG. 2 is a schematic diagram for explaining a comparison between a conventional technique and the first embodiment;

FIG. 3 is a graph showing a relation between a reproduction speed (n in 1/n times speed) and a motion-blur correction amount α;

FIG. 4 is a schematic diagram for explaining an anisotropic Gaussian Kernel;

FIG. 5 is a flowchart of a motion-blur correction process according to the first embodiment;

FIG. 6 is a flowchart of an interpolation-image creating process; and

FIG. 7 is a block diagram of a functional configuration of an image processing apparatus according to a second embodiment of the present invention.

### DETAILED DESCRIPTION OF THE INVENTION

Exemplary embodiments of an image processing apparatus, an image processing method, and a computer program product for image processing according to the present invention will be explained below in detail with reference to the accompanying drawings.

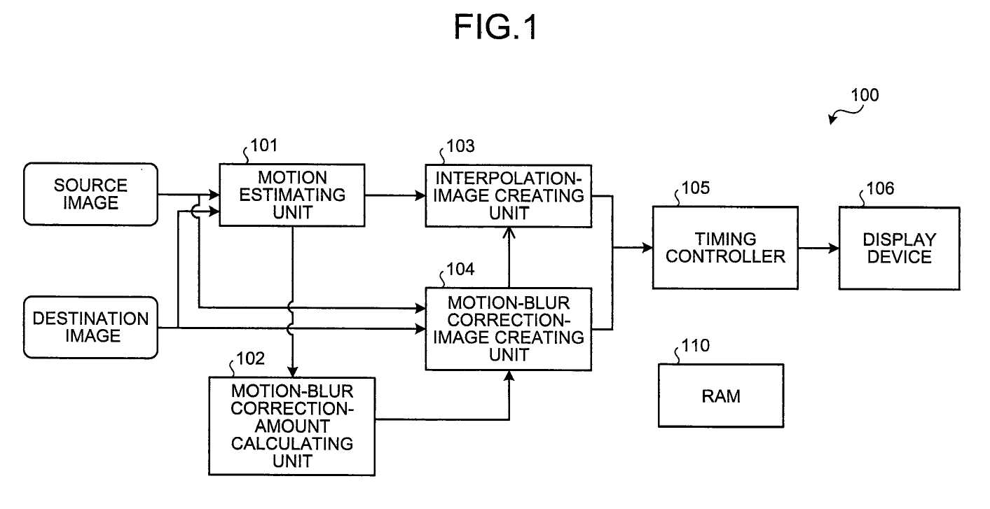

An image processing apparatus 100 according to a first embodiment of the present invention has a functional configuration shown in FIG. 1. The image processing apparatus 100 according to the first embodiment receives moving images, performs frame interpolation according to a reproduction speed that is designated by a user, and performs reproduction in a varied reproduction speed such as slow reproduction. The image is an aggregate of the flame and the moving image includes successive flames.

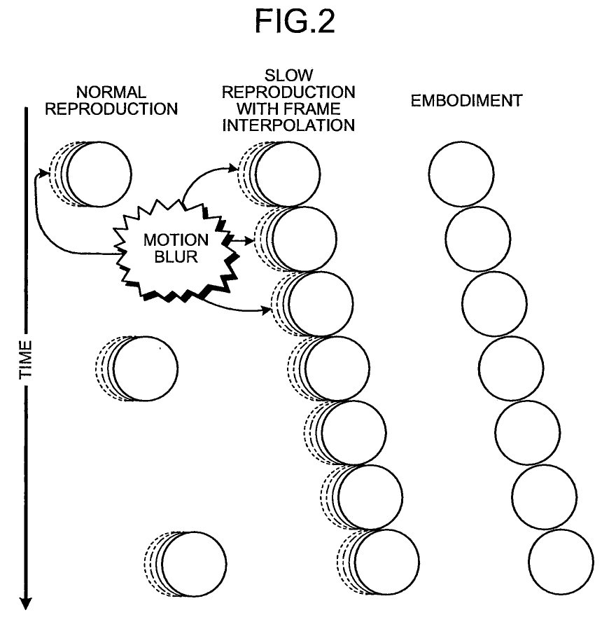

When moving images are imaged by a video camera, a motion blur is caused on an imaged object depending on a moving speed of the object and a shutter speed (exposure time). If the shutter speed is fixed, as the object moves faster, the motion blur is more likely to be caused. Playing in slow motion is equivalent to making the movement of an object relatively slow. Considering this, if the movement of the object becomes slow, the motion blur should appear less. However, as shown at the center in FIG. 2, if frames of original images of the input moving images are used as they are to perform the frame interpolation, the slow reproduction is to be performed using great motion blurs. As a result, the images appear unnaturally. At the left and the center in FIG. 2, a state where a plurality of circles are overlapped, as the circle goes to left, the line becomes thin, and then changes to a dashed-dotted line to a dotted line indicates that a motion blur is caused.

The image processing apparatus 100 according to the first embodiment calculates a motion-blur correction amount that is a value to cancel a motion blur depending on a designated reproduction speed, performs motion-blur correction on at least one flame based on the calculated motion-blur correction amount to convert into images of frames of motion blurs that are suitable for the reproduction speed, and creates interpolation images using the converted frames. Thus, smooth slow reproduction with motion blurs suitable for the reproduction speed is enabled as shown at the right in FIG. 2.

The image processing apparatus 100 according to the first embodiment includes, as shown in FIG. 1, a motion estimating unit 101, a motion-blur correction-amount calculating unit 102, an interpolation-image creating unit 103, a motion-blur correction-image creating unit 104, a timing controller 105, a display device 106, and a random access memory (RAM) 110.

The display device 106 is a monitor or the like that displays reproduced images. The RAM 110 is a memory that temporarily stores interpolation pixels of an interpolation image or a calculated motion-blur correction amount at the time of creation of an interpolation image.

The motion estimating unit 101 estimates a motion vector of each pixel from a source image to a destination image that are temporally adjacent to each other in input moving images by a block matching method. Adjacent two frames at an arbitrary time in the input moving images are regarded as the source image and the destination image. The frame rate of the input moving images is arbitrarily determined and is 30 frames per second (fps), for example. However, it is not limited thereto. Moreover, while the frame rate at the time of output is also arbitrarily determined and is 30 fps as an example, it is not limited thereto.

While in the first embodiment, the block matching method is used as a method of motion estimation, it is not limited thereto, and other methods, such as an optical flow method, Pel-recursive, and a Bayesian method, can be used.

Motion estimation by the block matching method performed by the motion estimating unit 101 is explained below. The source image is divided into blocks of rectangular areas that are indicated by Equation (1) and are set in advance.

B(i)={i+(x,y)^{T}|0≦x≦M₁,0≦y≦M₂} (1)

point iεX: Point at upper left of block

M₁, M₂: x size, y size of block

X⊂Λ²: Frame

A block matching algorism according to a sum of squared difference (SSD) is expressed as Equation (2).

$$u ( i ) = arg {min}_{u ∈ W} E ( i , u ) ≡ {\sum }_{x ∈ B ( i )} {( {I}_{dst} ( i + u + x ) - {I}_{src} ( i + x ) )}^{2} \qquad ( 2 )$$

W⊂X: Area of motion search

I_{src}(x): Pixel value of source image

I_{dst}(x): Pixel value of destination image

u(i)εX: Motion vector of block i

In the block matching, it is assumed that motion vectors in a block are identical. Therefore, a motion vector u of each pixel is expressed as Equation (3).

u(i+x)≡u(i),∀xεB(i) (3)

The motion-blur correction-amount calculating unit 102 calculates a motion-blur correction amount to cancel a motion blur of moving images based on the reproduction speed that is set by a user.

In the first embodiment, a motion-blur correction amount is expressed in a real value from 0 to 1, defining that a level at which the motion blur correction is completely performed to completely cancel a motion blur is 1.0, and a level at which the motion blur correction is not performed at all is 0.0.

When the reproduction speed of moving images is ½ times speed, the speed of an object in the moving images is ½ relatively. When the reproduction speed of moving images is ¼ times speed, the speed of an object in the moving images is ¼ relatively. Similarly, when the reproduction speed of moving images is ⅛ times speed, the speed of an object in the moving images is ⅛ relatively. Based on this, a 1/n time speed and a relative object speed are proportional to each other. A relative object speed and an amount of a motion blur are proportional to each other, and when the relative object speed is ½, the amount of the motion blur is ½. When the relative object speed is 0, a motion blur is not caused at all. Accordingly, the motion-blur correction-amount calculating unit 102 calculates a motion-blur correction amount α for a designated reproduction speed (1/n) from Equation (4).

$$α = 1.0 - \frac{1}{n} \qquad ( 4 )$$

n>0: Reproduction speed 1/n time speed

A relation between the reproduction speed (n of 1/n time speed) and the motion-blur correction amount α is shown in FIG. 3. As shown in FIG. 3, the correction amount α—0.0 at the time of 1/1 times speed, 0.5 at the time of ½ time speed, and 0.9 at the time of 1/10 times speed. Thus, as n increases, the value becomes closer to 1.0. That is, the motion-blur correction amount α takes a larger value close to the maximum value of 1 as the reproduction speed (1/n times speed) of moving images becomes slower and as n becomes larger.

While in the first embodiment, the motion-blur correction amount α of a reproduction speed (1/n time speed) of moving images is calculated from Equation (4), it can be configured such that correction is performed on the motion-blur correction amount α by the motion-blur correction-amount calculating unit 102, and a correction value thus obtained is used as a motion-blur correction amount α′.

For example, the motion-blur correction-amount calculating unit 102 can be configured to correct the motion-blur correction amount α using an input frame rate r_{src} [fps] at the time of input of moving images and a display frame rate r_{dst} [fps] at the time of display of the moving images as shown in Equation (5), and to use the correction value α′ as the motion-blur correction amount. This is based on a fact that while the motion blur is to be relatively small when the frame rate is high because a high frame rate and a high shutter speed are correlative, the motion blur is to be large when the frame rate is low.

$${α}^{′} = \frac{{r}_{dst}}{{r}_{src}} α \qquad ( 5 )$$

r_{src}: Frame rate [fps] of input moving images

r_{dst}: Display frame rate [fps]

where α=1 when r_{dst}>r_{src}

The motion-blur correction-image creating unit 104 performs scale transformation on a motion vector u(x) by the motion-blur correction amount α, and performs the motion blur correction on the source image and the destination image based on the motion vector on which the scale transformation has been performed.

Specifically, the motion-blur correction-image creating unit 104 multiplies the motion vectors u(x) of all points x by the motion-blur correction amount α that is calculated by the motion-blur correction-amount calculating unit 102 as shown in Equation (6), to perform the scale transformation on the motion vector of the all points x. The motion vector subjected to the scale transformation is expressed as u_{comp}.

u_{comp}(x)=αu(x),∀xεX (6)

u_{comp}: Motion vector after correction

Next the motion-blur correction-image creating unit 104 performs the motion blur correction on a source image I_{src}(x) and a destination image I_{dst}(x) that are original images in the input moving images, based on a motion vector u_{comp}(x) subjected to the scale transformation, to create a motion-blur correction image of the source image I_{src}(x) and a motion-blur correction image of the destination image I_{dst}(x).

The motion-blur correction-image creating unit 104 according to the first embodiment uses edge enhancement as a method of the motion blur correction performed on the source image I_{src}(x) and the destination image I_{dst}(x). That is, the motion-blur correction-image creating unit 104 creates the motion-blur correction image of the source image I_{src}(x) and the motion-blur correction image of the destination image I_{dst}(x) by performing an edge enhancement process on the source image I_{src}(x) and the destination image I_{dst}(x) using the motion vector u_{comp}(x) subjected to the scale transformation.

An unsharp mask is a well-known method for the edge enhancement. In the unsharp mask, smoothed images (low frequency components) are taken away from the original images by a Gaussian filter and the like, thereby extracting high frequency components. The extracted high frequency components are multiplied by a predetermined enhancement coefficient. The high frequency components on which the enhancement coefficient has been multiplied are added to the smoothed images (low frequency components), thereby obtaining images in which the high frequency components, that is, edges are enhanced. This method is based on that difference of Gaussian is approximated to laplacian (secondary differential).

Although in the edge enhancement method by the unsharp mask, an isotropic Gaussian filter is used usually, information of motion is not used with the isotropic Gaussian filter. Therefore, edge components appropriate for the motion blur is not necessarily extracted.

Therefore, the motion-blur correction-image creating unit 104 according to the first embodiment uses an anisotropic Gaussian filter that is determined by a direction and a size of the motion vector u_{comp}(x) subjected to the scale transformation, and acquires respective low frequency components (smoothed images) of the source image I_{src}(x) and the destination image I_{dst}(x) by this anisotropic Gaussian filter. The motion-blur correction-image creating unit 104 acquires difference between the source image I_{src}(x) and the low frequency components thereof and between the destination image I_{dst}(x) and the low frequency components thereof as the respective high frequency components of the source image I_{src}(x) and the destination image I_{dst}(x). The motion-blur correction-image creating unit 104 then multiplies each of the high frequency components by an enhancement coefficient a, and adds each of the high frequency components on which the enhancement coefficient a has been multiplied to each of the low frequency components, thereby creating a motion-blur correction image I_{src-comp}(x) of the source image I_{src}(x) and a motion-blur correction image I_{dst-comp}(x) of the destination image I_{dst}(x) that are the source image I_{src}(x) and the destination image I_{dst}(x) in which edges are enhanced, respectively.

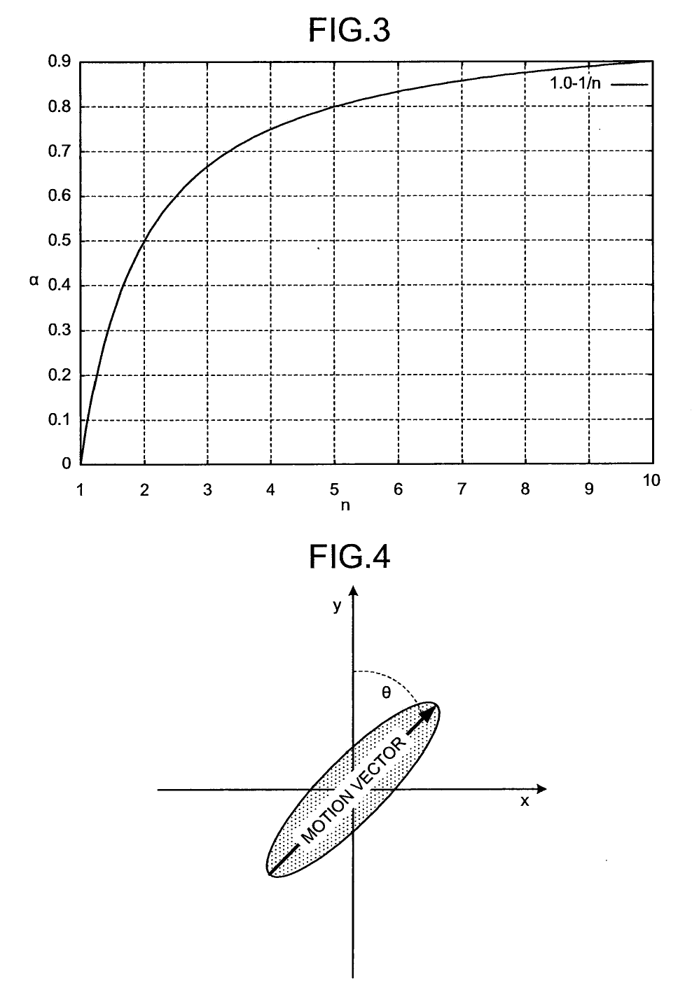

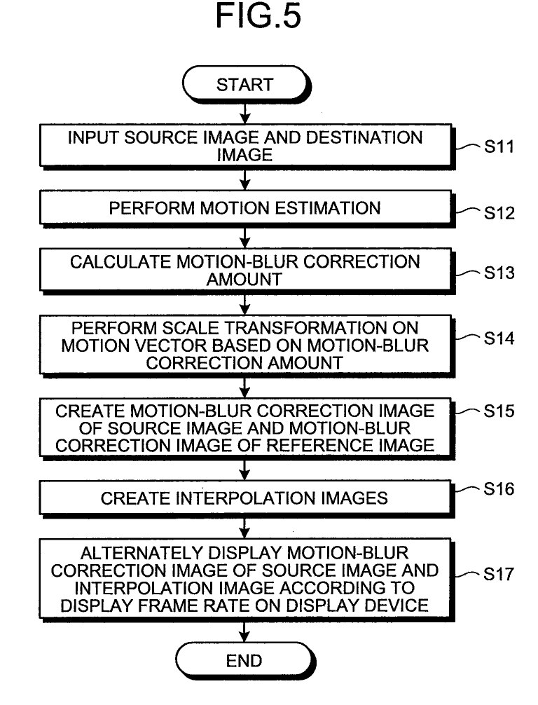

FIG. 4 is a schematic diagram for explaining a Gaussian Kernel (anisotropic Gaussian Kernel) of the anisotropic Gaussian filter. In the example shown in FIG. 4, a covariance matrix of the anisotropic Gaussian Kernel when an angle of the motion vector u_{comp}(x) is θ is calculated by Equations (7-1) to (7-3).

$$\begin{matrix}C = σ U Λ {U}^{T} & ( 7 \text{-} 1 ) \\ U = [ \begin{matrix}cos θ & sin θ \\ - sin θ & cos θ\end{matrix} ] , Λ = [ \begin{matrix}σ & 0 \\ 0 & \frac{1}{\partial }\end{matrix} ] & ( 7 \text{-} 2 ) \\ σ = \frac{1}{2} {‖ {u}_{comp} ( x ) ‖}_{2} \\ {‖ ‖}_{2} \text{:} {L}^{2} norm & ( 7 \text{-} 3 )\end{matrix}$$

A filter coefficient of the anisotropic Gaussian Kernel is calculated by Equation (8).

$$k ( s ) = exp ( - \frac{{s}^{T} Cs}{2 {σ}^{2}} ) \qquad ( 8 )$$

s: Relative coordinate in filter

An image (low frequency component) I_{q}(x) obtained by smoothing an original image I(x) using the anisotropic Gaussian filter is calculated by Equation (9).

$${I}_{g} ( x ) = \frac{{\sum }_{s ∈ N} k ( s ) I ( x + s )}{{\sum }_{s ∈ N} k ( s )} \qquad ( 9 )$$

N: Neighborhood of filtering

Accordingly, because a high frequency component v(x) is obtained by taking out the smoothed image (low frequency component) I_{g}(x) from the original image I(x), the high frequency component v(x) is calculated by Equation (10-1). Moreover, an image obtained by multiplying the high frequency component v(x) by the enhancement coefficient a (≧1.0) and by adding to the smoothed image I_{g}(x) is an image in which edges are enhanced, that is, a motion blur correction image I_{comp} of the original image. Therefore, the motion blur correction image I_{comp} is calculated by Equation (10-2).

v(x)=I(x)−I_{g}(x) (10-1)

I_{comp}(x)=I_{g}(x)+av(x) (10-2)

a≧1.0: Enhancement coefficient

Applying Equations (9), (10-1), and (10-2) to the source image I_{src}(x) and the destination image I_{dst}(x), the motion-blur correction-image creating unit 104 calculates Equations (11-1) to (11-3) for all points x to create the motion-blur correction image I_{src-comp}(x) of the source image I_{src}(x). Furthermore, the motion-blur correction-image creating unit 104 calculates Equations (12-1) to (12-3) for all points x to create the motion-blur correction image I_{dst-comp}(x) of the destination image I_{dst}(x).

$$\begin{matrix}{I}_{src - comp} ( x ) = {I}_{src - g} ( x ) + av ( x ) & ( 11 \text{-} 1 ) \\ v ( x ) = {I}_{src} ( x ) - {I}_{src - g} ( x ) & ( 11 \text{-} 2 ) \\ {I}_{src - g} ( x ) = \frac{{\sum }_{s ∈ N} k ( s ) {I}_{src} ( x - s )}{{\sum }_{s ∈ N} k ( s )} & ( 11 \text{-} 3 ) \\ {I}_{dst - comp} ( x ) = {I}_{dst - g} ( x ) + av ( x ) & ( 12 \text{-} 1 ) \\ v ( x ) = {I}_{dst} ( x ) - {I}_{dst - g} ( x ) & ( 12 \text{-} 2 ) \\ {I}_{dst - g} ( x ) = \frac{{\sum }_{s ∈ N} k ( s ) {I}_{dst} ( x + s )}{{\sum }_{s ∈ N} k ( s )} & ( 12 \text{-} 3 )\end{matrix}$$

I_{src-g}(x) is an image (low frequency component) that is obtained by smoothing the source image I_{src}(x) by the anisotropic Gaussian filter, and I_{dst-g}(x) is an image (low frequency component) that is obtained by smoothing the destination image I_{dst}(x) by the anisotropic Gaussian filter.

While the motion vector u_{comp}(x) is present in the source image, it is not present in the destination image. In this case, such a process that motion estimation processing performed by the motion estimating unit 101 is delayed by 1 frame should be performed.

While in the first embodiment, the high frequency component v(x) and the motion-blur correction image I_{comp}(x) are acquired by Equations (10-1) and (10-2), respectively, it can be configured to calculate the high frequency component by Equation (13-1) and the motion-blur correction image I_{comp}(x) by Equation (13-2).

$$\begin{matrix}v ( x ) = \frac{I ( x ) + 1}{{I}_{g} ( x ) + 1} & ( 13 \text{-} 1 ) \\ {I}_{comp} ( x ) = {I}_{g} ( x ) {v ( x )}^{a} & ( 13 \text{-} 2 )\end{matrix}$$

The image is modeled by the product of the low frequency component and the high frequency component. That is, Equation (13-1) expresses that the high frequency component v(x) is acquired by dividing a term including an original image (a source image or a destination image) I(x) by a term including the low frequency component I_{g}(x). Equation (13-2) expresses that the motion-blur correction image I_{comp}(x) is acquired by exponentiating the high frequency component v(x) by the enhancement coefficient a, and by multiplying by the low frequency component.

While in the first embodiment, the processing of the motion-blur correction image creation is implemented by the edge enhancement as described above, it can also be implemented using an inverse filter.

The interpolation-image creating unit 103 creates an interpolation image using the motion vector u(x) from the source image and the destination image on which the motion blur correction has been performed (specifically, the motion-blur correction image I_{src-comp}(x) of the source image I_{src}(x) and the motion blur correction image I_{dst-comp}(x) of the destination image I_{dst}(x)).

The interpolation-image creating unit 103 creates an interpolation image by shifting the source image I_{src-comp}(x) that is the source image on which the motion blur correction has been performed and the destination image I_{dst-comp}(x) that is the destination image on which the motion blur correction has been performed using the motion vector u_{comp}(x) subjected to the scale transformation. An interpolation position is shifted by the motion vector u_{comp}(x) subjected to the scale transformation. When the reproduction speed is 1/n time speed, n−1 pieces of interpolation images are created and interpolated between frames of the source image I_{src-comp}(x) and the destination image I_{dst-comp}(x) If an interpolation time position of the interpolation images is 0≦t≦1, the interpolation position is calculated by Equation (14).

z₀=└x+tu(x)┘ (14)

└x┘: Operator to round down x component and y component of x

A pixel value I₁ of the source image I_{src-comp}(x) and a pixel value I₂ of the destination image I_{dst-comp}(x) with respect to the point x are expressed as Equations (15-1) and (15-2).

I₁=I_{src-comp}(x) (15-1)

I₂=I_{dst-comp}(x+u(x)) (15-2)

If the interpolation time position of an interpolation image is 0≦t≦1, the interpolation-image creating unit 103 calculates a pixel value (interpolation pixel value) of an interpolation image by a weighted average of time t using Equation (16).

I_{mc}=(1−t)I₁+tI₂ (16)

There can be an area in which pixels overlap with each other as a result of shifting. In this case, such a process that a pixel whose inter-frame residual |I₁-I₂| is smaller is used should be performed. Furthermore, there can be a part in which a hole is made. As for a small hole, the hole can be filled by filtering. As for a large hole, the hole can be filled by a time average image indicated by Equation (17).

Iₜ(x)=(1−t)I_{src-comp}(x)+tI_{dst-comp}(x) (17)

The timing controller 105 alternately outputs the source image I_{src-comp}(x) subjected to the motion blur correction and the interpolation image that is created by the interpolation-image creating unit 103 to the display device 106 according to the display frame rate. For example, when 1/n time speed is designated as the reproduction speed of the moving images, after the source image I_{src-comp}(x) is displayed, n−1 pieces of the interpolation images are output.

Next, the motion blur correction according to the first embodiment performed as described above is explained with reference to FIG. 5. First, the image processing apparatus 100 receives moving images to be reproduced, and designation of a reproduction speed (1/n times speed) from a user. The motion estimating unit 101 inputs the source image I_{src}(x) and the destination image I_{dst}(x) from the input moving images (step S11), and performs motion estimation, that is, estimates the motion vector u(x) from the source image I_{src}(x) to the destination image I_{dst}(x) by the block matching method (step S12).

Subsequently, the motion-blur correction-amount calculating unit 102 calculates the motion-blur correction amount α based on the designated reproduction speed (1/n time speed) using Equation (4) (step S13). The calculated motion-blur correction amount α is temporarily stored in the RAM 110.

The motion-blur correction-image creating unit 104 corrects the motion vector u(x) with the calculated motion-blur correction amount α using Equation (6) (step S14). The motion-blur correction-image creating unit 104 then performs the motion blur correction on the source image I_{src}(x) and the destination image I_{dst}(x) using the motion vector u_{comp}(x) subjected to the scale transformation by Equations (11-1) to (11-3), and Equations (12-1) to (12-3) to create the motion-blur correction image I_{src-comp}(x) of the source image I_{src}(x) and the motion-blur correction image I_{dst-comp}(x) of the destination image I_{dst}(x) (step S15). The respective created images are temporarily stored in the RAM 110.

Next, the interpolation-image creating unit 103 creates interpolation images from the motion-blur correction image I_{src-comp}(x) of the source image I_{src}(x) and the motion-blur correction image I_{dst-comp}(x) of the destination image I_{dst}(x) (step S16).

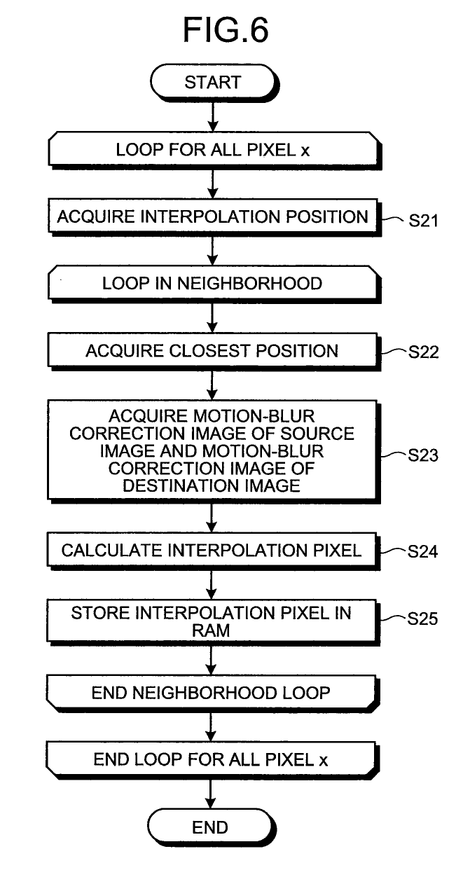

The interpolation image creation at step S16 is explained with reference to FIG. 6. The interpolation-image creating unit 103 repeats processes of steps S21 to S25 described below for each pixel x.

First, the interpolation-image creating unit 103 acquires an interpolation position from Equation (14) (step S21). The interpolation-image creating unit 103 then repeats processes of steps S22 to S25 below on neighborhood positions (i=0, 1, j=0, 1) of the interpolation position.

The interpolation-image creating unit 103 acquires the closest position of the interpolation position by Equation 18 (step S22), and then acquires the motion-blur correction image I_{src-comp}(x) of the source image I_{src}(x) and the motion-blur correction image I_{dst-comp}(x) of the destination image I_{dst}(x) from the RAM 110 (step S23). The interpolation-image creating unit 103 calculates an interpolation pixel by Equation 16 (step S24), and stores the calculated interpolation pixel in the RAM 110 (step S25). By performing such a process on all neighborhood positions and all the pixels x, the interpolation images are created in the RAM 110, and the created interpolation images are interpolated in interpolation positions.

zₙₑₐᵣ=z₀+(i,j)^{T} (18)

Referring back to FIG. 5, when the interpolation image is created at step S16, the timing controller 105 alternately outputs the source image I_{src-comp}(x) that is the source image on which the motion blur correction has been performed and the interpolation image created by the interpolation-image creating unit 103 to the display device 106 according to the display frame rate (step S17).

As described above, because in the image processing apparatus 100, the motion-blur correction amount is calculated according to the designated reproduction speed, the motion blur correction is performed on the source image and the destination image based on the calculated motion-blur correction amount to convert into an image suitable for the reproduction speed, and the interpolation image is created using the converted image. Therefore, even if the reproduction speed is changed, smooth reproduction can be achieved because of the motion blur correction appropriate for the reproduction speed.

A second embodiment of the present invention is a virtual slow imaging function incorporated in an imaging device such as a video camera. Originally, when slow imaging is performed in real, a high speed imaging device is necessary. For example, to perform slow imaging of 1/n times speed, an imaging device that acts in n times faster is required. Therefore, in the second embodiment, slow imaging is performed virtually by frame interpolation.

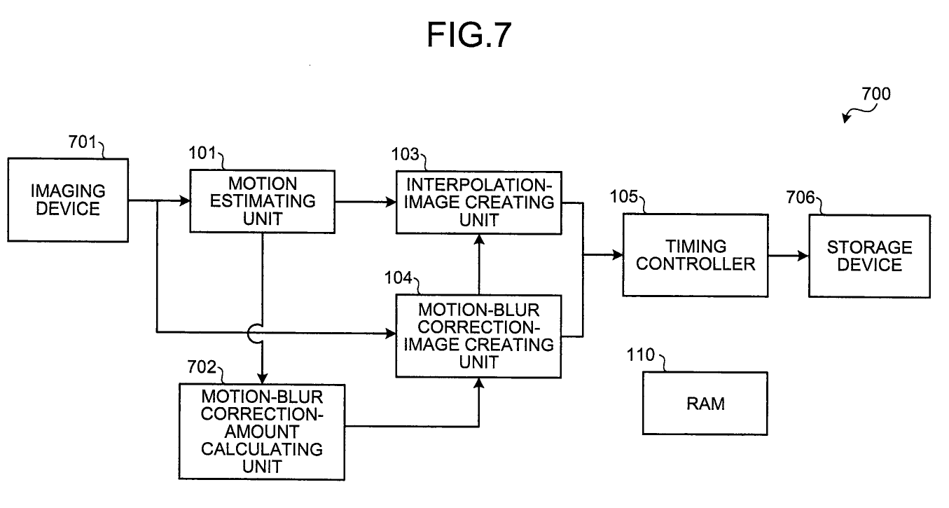

An image processing apparatus 700 according to the second embodiment includes, as shown in FIG. 7, an imaging device 701, the motion estimating unit 101, a motion-blur correction-amount calculating unit 702, the interpolation-image creating unit 103, the motion-blur correction-image creating unit 104, the timing controller 105, a storage device 706, and the RAM 110, mainly.

The motion estimating unit 101, the interpolation-image creating unit 103, the motion-blur correction-image creating unit 104, the timing controller 105, and the RAM 110 are the same as those in the first embodiment.

The imaging device 701 is, for example, a camera system in which an imaging device, such as a charge-coupled device (CCD) and a complementary metal oxide semiconductor (CMOS), is incorporated. The imaging device 701 includes an imaging device, a light collecting device such as a lens, and a control device for exposure, white balance, and the like (all not shown). The imaging device 701 images external light as image data such as RGB, and outputs the image data to the motion estimating unit 101 and the motion-blur correction-image creating unit 104 as temporally sequential moving images.

The motion-blur correction-amount calculating unit 702 according to the second embodiment calculates a motion-blur correction amount to cancel a motion blur of moving images based on the reproduction speed designated by a user using Equation (4) similarly to the first embodiment, and corrects the motion-blur correction amount based on information on a shutter speed (exposure time) that is received from the imaging device 701. The motion-blur correction amount thus corrected is used as a motion-blur correction amount.

At the slowest shutter speed, the motion blur is largest, and as the shutter speed increases, the motion blur decreases. Therefore, the motion-blur correction-amount calculating unit 702 corrects the motion-blur correction amount α acquired by Equation (4) based on the shutter speed (exposure time) using Equation (19). This correction value α′ is used as the motion-blur correction amount for motion-blur correction image creation to be performed thereafter.

$${α}^{′} = \frac{s}{{S}_{max}} α \qquad ( 19 )$$

Sₘₐₓ: Longest exposure time

s: Current exposure time (shutter speed)

The storage device 706 is a recording medium such as a memory and a hard disk drive (HDD) that stores image data that is made into virtually slow images by interpolating interpolation images. This image data can be compressed by moving image coding to be stored.

The motion blur correction according to the second embodiment performed as described above is performed similarly to the first embodiment except that the motion-blur correction amount α′ calculated by Equation (19) is used as the motion-blur correction amount.

As described above, in the image processing apparatus 700 according to the second embodiment, similarly to the first embodiment, smooth reproduction can be achieved even if the reproduction speed is changed, because of the motion blur correction appropriate for the reproduction speed. Moreover, in the image processing apparatus 700 according to the second embodiment, slow imaging and the like are performed virtually by the frame interpolation, and further, the motion blur correction suitable for the reproduction speed is possible. Therefore, it is not necessary to use a high performance imaging device.

The image processing apparatuses according to the first and second embodiments include a control device such as a central processing unit (CPU), a storage device such as a read only memory (ROM) and a RAM, an external storage device such as an HDD and a compact disk (CD) drive, a display device, and an input device such as a keyboard and a mouse, and has a hardware configuration using an ordinary computer.

An image processing program that is executed in the image processing apparatus according to the first and second embodiments is recorded in a file in an installable or executable format on a computer-readable recording medium such as a compact-disk ROM (CD-ROM), a flexible disk (FD), a CD-recordable (CD-R), and a digital versatile disk (DVD), to be provided.

Alternatively, the image processing program that is executed in the image processing apparatus according to the first and second embodiments can be recorded on a ROM or the like in advance, to be provided.

The image processing program that is executed in the image processing apparatus according to the first and second embodiments has a module configuration including the respective parts (the motion estimating unit 101, the motion-blur correction-amount calculating units 102 and 702, the interpolation-image creating unit 103, the motion-blur correction-image creating unit 104, and the timing controller 105) described above, and as an actual hardware, a CPU reads the image processing program from the above recording medium and executes the program. As a result, the respective parts are loaded on a main storage device. Thus, the motion-blur correction-amount calculating units 102 and 702, the interpolation-image creating unit 103, the motion-blur correction-image creating unit 104, and the timing controller 105 are created on the main storage device.

The present invention is not limited to the above embodiments as they are, and constituent elements can be variously modified and put into practice within the scope of the invention during an implementation stage. Further, suitable combinations of the plurality of constituent elements disclosed in the above embodiments can create various inventions. For example, some of the whole constituent elements disclosed in the above embodiments can be omitted. Further, the constituent elements according to different embodiments can be suitably combined with each other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus that interpolates an interpolation image corresponding to a reproduction speed between a source image and a destination image, the apparatus comprising:
a motion estimating unit that estimates a motion vector of each pixel from the source image to the destination image;
a correction-amount calculating unit that calculates a motion-blur correction amount, which takes a larger value as the reproduction speed becomes lower, based on an input reproduction speed;
a motion-blur correcting unit that performs scale transformation on the motion vector based on the motion-blur correction amount, and corrects a motion blur of the source image and the destination image based on the motion vector subjected to the scale transformation; and
an interpolation-image creating unit that creates the interpolation image using the source image for which the motion blur is corrected, the destination image for which the motion blur is corrected, and the motion vector, wherein
the motion-blur correcting unit acquires respective low frequency components of the source image and the destination image by using an anisotropic Gaussian filter that is determined by a direction and a size of a motion vector subjected to a scale transformation, and performs edge enhancement on the source image and the destination image based on the low frequency components and respective high frequency components of the source image and the destination image, thereby correcting the motion blur of the source image and the destination image.

2. The apparatus according to claim 1, wherein the motion-blur correcting unit acquires the high frequency components as a difference between the source image and the low frequency component, and between the destination image and the low frequency component, multiplies the high frequency component by a predetermined enhancement coefficient, and adds the high frequency component on which the enhancement coefficient has been multiplied to the low frequency component, thereby performing the edge enhancement on the source image and the destination image.

3. The apparatus according to claim 1, wherein the motion-blur correcting unit acquires the high frequency component by dividing the source image and the destination image by the low frequency component, exponentiates the high frequency component by the predetermined enhancement coefficient, and multiplies the low frequency component by the high frequency component that has been exponentiated by the enhancement coefficient, thereby performing the edge enhancement on the source image and the destination image.

4. The apparatus according to claim 1, wherein
the correction-amount calculating unit further corrects the motion-blur correction amount by a ratio of an input frame rate of the input images and a display frame rate at the time of display, and
the motion-blur correcting unit performs the scale transformation on the motion vector based on the corrected motion-blur correction amount.

5. The apparatus according to claim 1, wherein
the correction-amount calculating unit further corrects the motion-blur correction amount by an exposure time of the input images, and
the motion-blur correcting unit performs the scale transformation on the motion vector based on the corrected motion-blur correction amount.

6. An image processing method executed in an image processing apparatus that interpolates an interpolation image corresponding to a reproduction speed between a source image and a destination image, the method comprising:
estimating a motion vector of each pixel from the source image to the destination image;
calculating a motion-blur correction amount, which takes a larger value as the reproduction speed becomes lower, based on an input reproduction speed;
performing scale transformation on the motion vector based on the motion-blur correction amount, and correcting a motion blur of the source image and the destination image based on the motion vector subjected to the scale transformation; and
creating the interpolation image using the source image for which the motion blur is corrected, the destination image for which the motion blur is corrected, and the motion vector, wherein
in the correcting, respective low frequency components of the source image and the destination image are acquired by using an anisotropic Gaussian filter that is determined by a direction and a size of a motion vector subjected to a scale transformation, and an edge enhancement on the source image and the destination image is performed based on the low frequency components and respective high frequency components of the source image and the destination image, thereby correcting the motion blur of the source image and the destination image.

7. A computer program product having a computer readable medium including programmed instructions for interpolating an interpolation image corresponding to a reproduction speed between a source image and a destination image, wherein the instructions, when executed by a computer, cause the computer to perform:
estimating a motion vector of each pixel from the source image to the destination image;
calculating a motion-blur correction amount, which takes a larger value as the reproduction speed becomes lower, based on an input reproduction speed;
performing scale transformation on the motion vector based on the motion-blur correction amount, and correcting a motion blur of the source image and the destination image based on the motion vector subjected to the scale transformation; and
creating the interpolation image using the source image for which the motion blur is corrected, the destination image for which the motion blur is corrected, and the motion vector, wherein
in the correcting, respective low frequency components of the source image and the destination image are acquired by using an anisotropic Gaussian filter that is determined by a direction and a size of a motion vector subjected to a scale transformation, and an edge enhancement on the source image and the destination image is performed based on the low frequency components and respective high frequency components of the source image and the destination image, thereby correcting the motion blur of the source image and the destination image.
